(19) United States
(12) Patent Application Publication
(10) Pub. No.: US 2012/0097619 A1
(43) Pub. Date: Apr. 26, 2012

(54) METHOD FOR KEEPING OZONE OF HIGH CONCENTRATION WHILE TURNING ON AN ELECTROLYSIS-TYPE OZONE DEVICE

(76) Inventor: Gavin HSU, ETDZ Yantai (CN)

(21) Appl. No.: 13/279,240

(22) Filed: Oct. 21, 2011

(30) Foreign Application Priority Data
Oct. 23, 2010 (CN) 201010531268.X

(51) Int. Cl. C02F 1/461; C25B 1/13; C02F 1/78

(52) U.S. Cl. 210/760; 205/626

(57) ABSTRACT

A method for keeping ozone of high concentration while turning on an electrolysis-type ozone device is provided with an ozone generator, a pure water tank, a pipe, another pipe, the other pipe, an ozone gas delivery pipe, and a DC power supply that provides electricity for the ozone generator and the controlling valve. When the ozone generator is turned off for a period, the DC power supply continues providing a half-loaded current for the ozone generator to operate; wherein, the half-loaded current is half smaller than a full-loaded current. When a predetermined time is reached, the DC power supply instantly offers the full-loaded current to the ozone generator, thereby triggering the ozone generator to automatically operate. The method automatically turns on the ozone generator to produce new ozone gas after the ozone device is turned off and stops discharging the ozone gas or the ozone water.

### CROSS-REFERENCE TO RELATED APPLICATION

This application claims priority from China Patent Application No. 201010531268.X, filed on Oct. 23, 2010, the contents of which are hereby incorporated by reference in their entirety for all purposes.

### BACKGROUND OF THE INVENTION

1. Field of the Invention

The present invention relates to a method for keeping ozone of high concentration while turning on an electrolysis-type ozone device that mainly cooperates with an ozone water generator.

2. Description of the Related Art

The existing method for generating ozone water mainly utilizes the ozone gas generated by an ozone generator to mix with water. Within a few minutes, the amount of the ozone gradually increases after the ozone generator is turned on. In the meantime, the concentration of the ozone water mixed by the ozone and the water is also augmented. Herein, an effect of disinfection is in fact unsatisfactory until certain concentration of the ozone water mixed by the ozone and the water is achieved. As a result, users have to wait for a while until the concentration of the ozone water is enough for sterilization. A Chinese utility model patent no. ZL200520113834.X discloses an ozone gas-water storage tank that turns on an ozone generator when an outlet for the ozone water and an inlet for the tap water are not open. Thereby, the ozone gas is stored in an ozone gas-water storage and mixing tank. Moreover, the amount of the stored ozone gas is controlled via properly managing the operating time of the ozone generator. When the ozone gas accumulates a predetermined amount, the ozone generator is turned off. Accordingly, the inlet for the tap water and the outlet for the ozone water are not open until the ozone generator is turned on again. While the tap water gets in the ozone gas-water storage and mixing tank, the tap water mixes with the ozone gas that is previously stored therein, so that the ozone water of high concentration is resulted and gets out from the outlet for the ozone water. Another Chinese patent no. CN200610043344.6 discloses a method for supplying power to electrolysis-type ozone generator that supplies normal operating electricity when the ozone generator is operated. When the ozone generator stops operating, a follow current that is smaller than the supplied current during the operation is provided.

However, both afore methods include the following shortcomings:

1. Generally, the ozone has half-life. The half-life of the ozone gas is about 4 to 20 hours, and the half-life of the ozone water is about 12 to 151 minutes. Wherein, if an intermission of turning on the ozone generator is too long, the ozone gas and the ozone water in the storage room naturally decline, thereby decreasing the ozone concentration. Thus, the moment the ozone generator is turned on, the concentration of the ozone water is not enough for sterilization. Namely, the longer intermission the ozone generator is turned on, the lower concentration of the ozone water is resulted. Even worse, the effort for sterilization is in vain.

2. The follow current that is smaller than the electricity supplied during the operation may be provided for ensuring enough concentration of the ozone is kept in the ozone generator while the ozone generator stops working However, the ozone declines and reduces quickly. Therefore, the replacement of the declined ozone requires a long time since the follow current is actually insufficient. Consequently, users still have to wait for the ozone generator starting sterilizing while turning on the ozone generator every time. Thus, it is impossible for users to utilize the ozone water of high concentration right in time of turning on the ozone generator. Additionally, a larger follow current may be provided for rapidly replacing the declined and reduced ozone, but this means that the ozone generator has to continue operating even it is turned off. Therefore, it is also impossible for users to utilize a larger follow current on the ozone generator since the larger follow current largely consumes the working life and wastes the electricity of the ozone generator.

### SUMMARY OF THE INVENTION

Accordingly, the object of the present invention is to conquer shortcomings existing in the current techniques by providing a method that could be easily controlled, and the cost is also low, thus contributing to considerable production. Thereby, while the ozone device of the present invention is electrified and under a preparing state, it is able to instantly provide ozone of high concentration in a starting stage. Thus, users can benefit from the ozone gas or the ozone water of high concentration when they turn on the ozone generator anytime. As a result, the present invention is favorable for the rapid sterilization.

The present invention is achieved as follows. The method for keeping high concentration of ozone in turning on the electrolysis-type ozone generator utilizes an ozone generator being connected to a pure water tank via a pipe and another pipe. The pure water tank is connected to the other pipe. The pipe is connected to an ozone gas delivery pipe. On the pipe and the ozone gas delivery pipe, a controlling valve is disposed to control an operation of the ozone generator. A DC power supply provides electricity for the ozone generator and the controlling valve. Ozone gas generated when the generator is turned on is stored in an internal above part of the pure water tank, the pipe and a storage room of the ozone gas delivery pipe via the pipe and an internal below part of the pure water tank. Characterized in that, when the ozone generator is turned off for a period, the DC power supply continues providing a half-loaded current (Im) for the ozone generator to operate; wherein, the half-loaded current (Im) is half smaller than a full-loaded current (If). When a predetermined time that is set in a range from 0.5 hour to 24 hours is reached every time, the DC power supply instantly offers the full-loaded current (If) to the ozone generator, thereby triggering the ozone generator to automatically operate for 0.5 minute to 60 minutes. The method is periodically and continuously applied.

Preferably, an ozone gas-water storage and mixing tank is disposed between the pipe and the ozone gas delivery pipe of the ozone generator. The ozone gas-water storage and mixing tank includes a tap water input pipe disposed at a top end thereof. The tap water input pipe is installed with the controlling valve. When the ozone generator is turned on for generating ozone, the ozone is stored in a storage room defined in the internal above part of the pure water tank, the pipe, and an internal above part of the ozone gas-water storage and mixing tank via the pipe and the internal below part of the pure water tank. The ozone and ozone water are further stored in the internal below part of the ozone gas-water storage and mixing tank and a storage room of the ozone gas delivery pipe.

Preferably, the ozone gas-water storage and mixing tank of the ozone device adopts a single gas storage jar or any other suited assemblies.

Preferably, the ozone generator adopts an ozone gas device that outputs ozone gas, an ozone air generator that outputs mixed ozone air, or an ozone water generator that outputs ozone water.

Preferably, the storage room in the ozone device is airtight.

The present invention includes the following advantages:

1. It is common that the ozone gas could be previously stored in a storage room that is airtight. Thereafter, when the ozone water is to be used, the inlet for tap water and the outlet for ozone water are open for mixing the water and the stored ozone gas. Accordingly, the ozone water that contains high concentration is achievable in time of turning on the ozone generator. However, afore method leaves out the half-life of the ozone. Namely, if the intermission of the turning on the ozone generator is too long, the concentration of the ozone water is in fact insufficient especially in time of turning on the ozone generator. Differently, the present invention allows the ozone generator to immediately provide new ozone gas anytime even the ozone generator is not used or the intermission of using is too long. By the new ozone gas entering the ozone storage rooms, the declined ozone could be replaced. Preferably, the concentration of the ozone could be maintained within a tolerable scope, thence allowing the ozone generator to be freely operated and provide the ozone water that is of high concentration. Two curves showing the differences between the performances of the conventional method and the present invention are provided in FIGS. 1, 1-1, 2, and 3.

2. In time of turning on the ozone generator, high concentration of ozone gas or ozone water is provided. Obviously, users do not have to wait for a period before the ozone generator starts sterilizing. Favorably, the ozone generator enhances its using life and prevents from large energy consumption. The ozone generator in accordance with the present invention gets rid of the utilization of the follow current but still thoroughly replaces the declined ozone.

3. The method of the present invention is suited to the existing mechanism. Namely, extra parts are not needed, but the cost is reduced, and the automation of the mechanism even advances.

### BRIEF DESCRIPTION OF THE DRAWINGS

FIG. 1 is a curve showing the relationship between the time and the concentration of the ozone gas after the ozone generator is turned off;

FIG. 1-1 shows the method for keeping high concentration of ozone:

1. A DC power supply continues providing a half-loaded current (Im) and a full-loaded current (If) for the ozone generator (1) to operate; wherein, the half-loaded current (Im) is half smaller than a full-loaded current (If);

2. A curve shows the relationship between the current and the time that when the ozone gas/water generator is turned off, the ozone generator operates in the circulation that every fifty-eight-minute half-loaded current follows a two-minute full-loaded current;

FIG. 2 is a curve showing the relationship between the time and the concentration of the ozone water in time of turning on the ozone generator after it is turned off for 12 hours;

FIG. 3 is a curve showing the relationship between the time and the concentration of the ozone water in time of turning on the ozone generator after it is turned off for 48 hours;

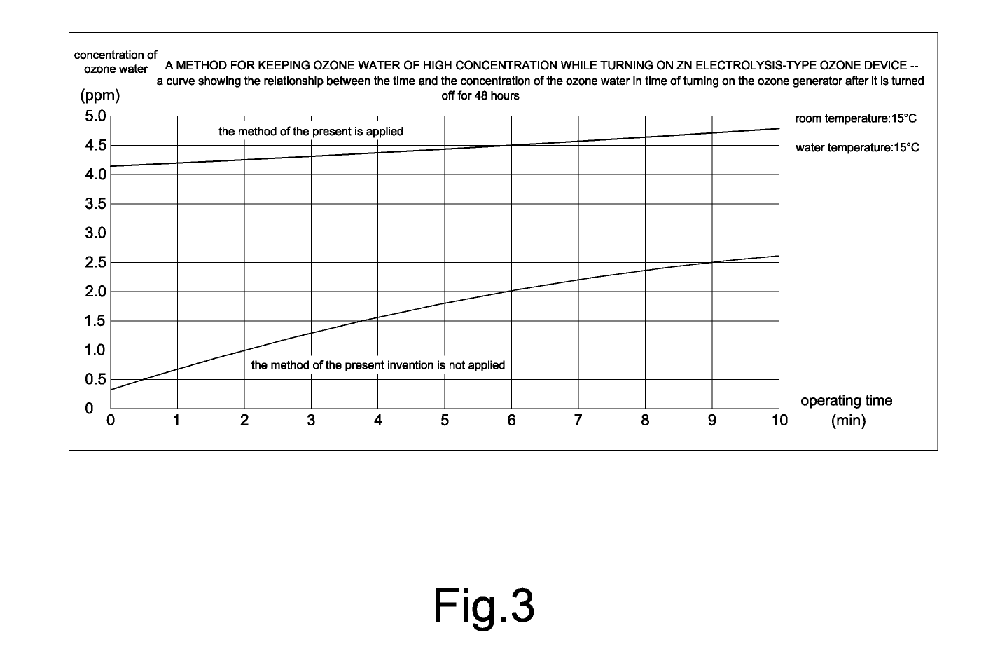

FIG. 4 is a schematic view showing the electrolysis-type ozone gas generator of the present invention; and

FIG. 5 is a schematic view showing the electrolysis-type ozone water generator of the present invention.

### DETAILED DESCRIPTION OF THE PREFEREED EMBODIMENTS

Figures and embodiments of the present invention are carefully depicted as follows.

### Embodiment 1

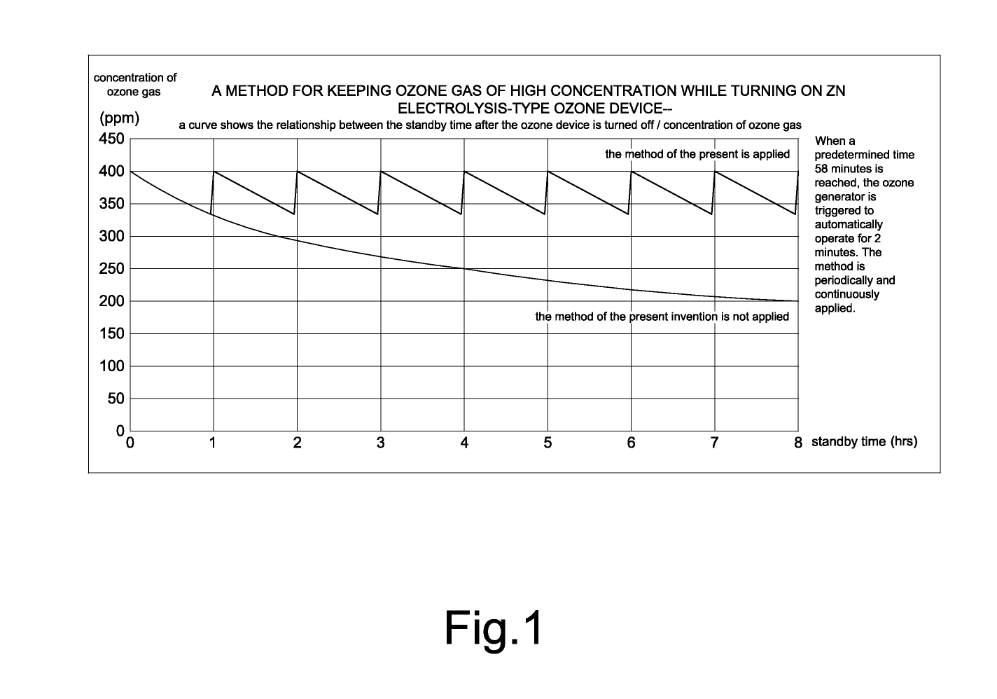

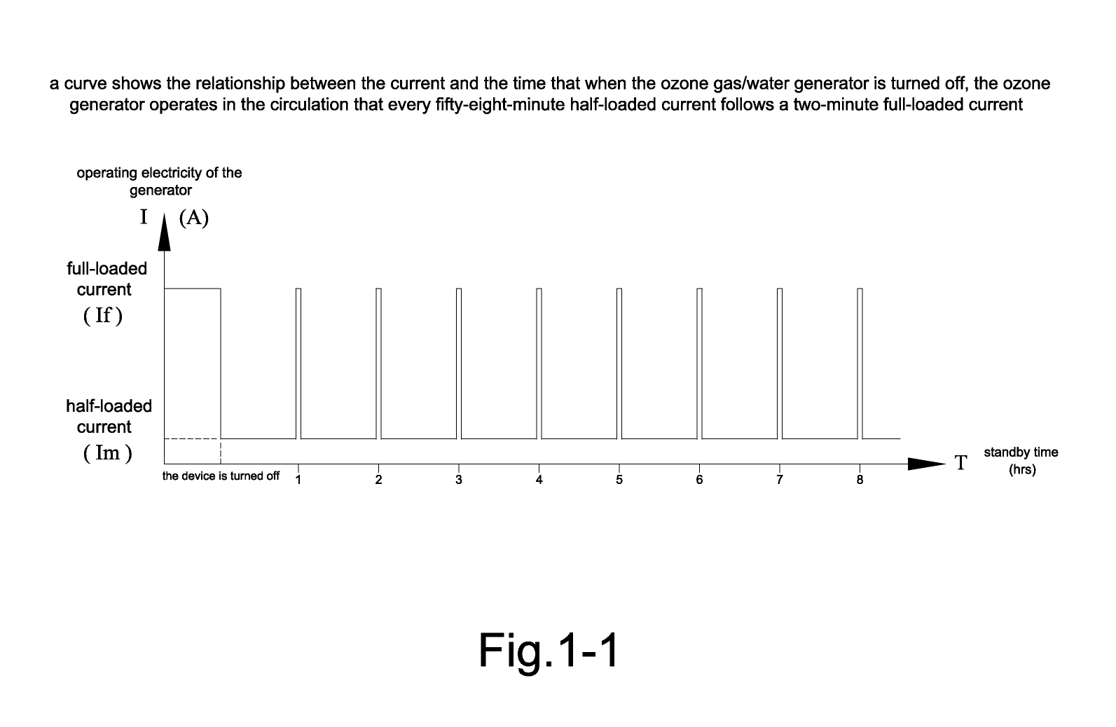

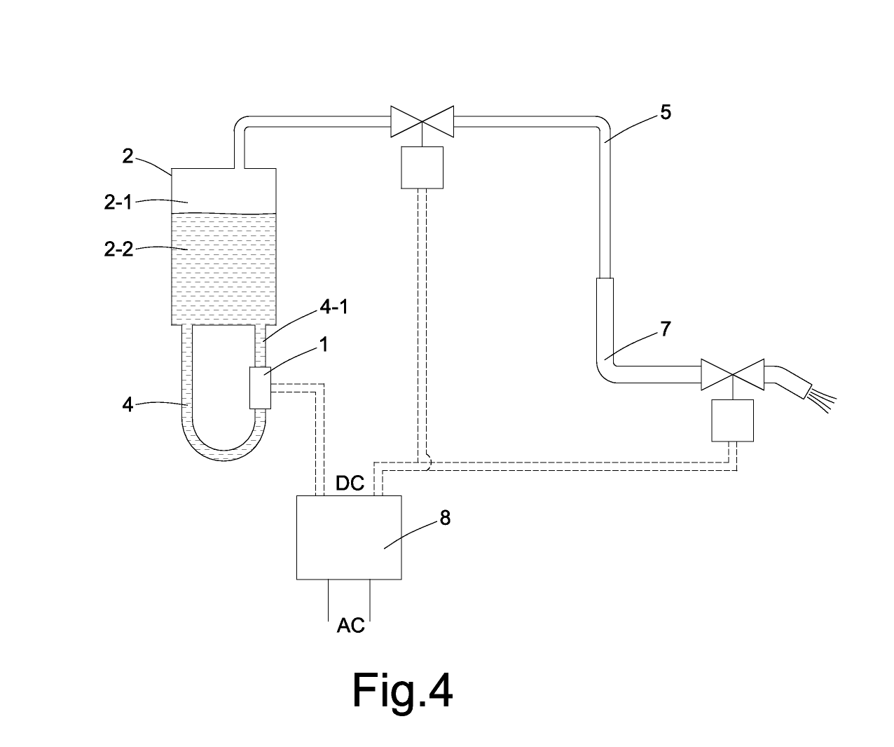

A method for keeping ozone of high concentration while turning on an electrolysis-type ozone gas device (as shown in FIGS. 1, 1-1, and 4) utilizes an ozone generator (1) connected to a pure water tank (2) via a pipe (4) and another pipe (4-1). The pure water tank (2) is connected to the other pipe (5). The pipe (5) is connected to an ozone gas delivery pipe (7). On the pipe (5) and the ozone gas delivery pipe (7), a controlling valve is disposed to control an operation of the ozone generator. A DC power supply (8) provides electricity for the ozone generator and the controlling valve. Ozone gas generated when the ozone generator is turned on is stored in an internal above part (2-1) of the pure water tank (2), the pipe (5) and a storage room of the ozone gas delivery pipe (7) via the pipe (4-1) and an internal below part (2-2) of the pure water tank (2). When the ozone generator is turned off for a period, the DC power supply (8) continues providing a half-loaded current (Im) for the ozone generator (1) to operate; wherein, the half-loaded current (Im) is half smaller than a full-loaded current (If). When a predetermined time 0.5 hour is reached, the DC power supply (8) instantly offers the full-loaded current (If) to the ozone generator, thereby triggering the ozone generator to automatically operate for 0.5 minute. The method is periodically and continuously applied.

### Embodiment 2

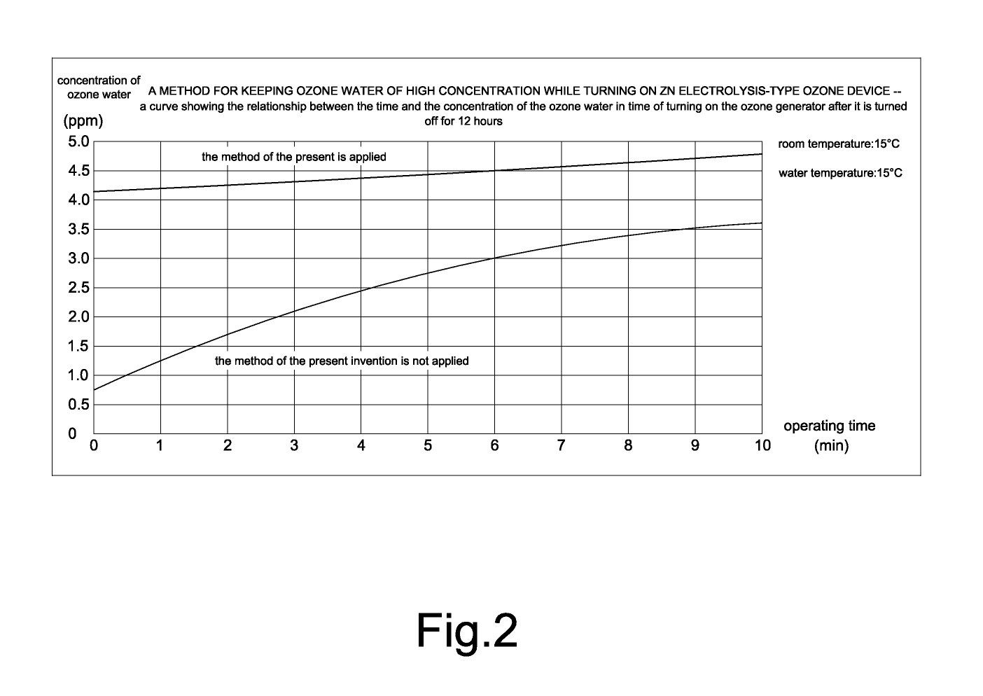

A method for keeping ozone of high concentration while turning on an electrolysis-type ozone water device (as shown in FIGS. 1, 1-1, 2, and 5) utilizes an ozone generator (1) connected to a pure water tank (2) via a pipe (4) and another pipe (4-1). A top side between the pure ware tank (2) and an ozone gas-water storage and mixing tank (3) is connected by the pipe (5). The ozone gas-water storage and mixing tank (3) includes a tap water input pipe (6) disposed at a top end thereof. The ozone gas-water storage and mixing tank (3) further includes the ozone gas delivery pipe (7) (or an ozone water delivery pipe (7)) disposed at a lower end thereof. The pipe (5), the tap water input pipe (6), and the ozone gas delivery pipe (7) are respectively installed with the controlling valve for triggering the ozone generator. The DC power supply (8) provides electricity for the ozone generator and the controlling valve. When the ozone generator (1) is turned on for generating ozone, the ozone is stored in a storage room defined in the internal above part (2-1) of the pure water tank (2), the pipe (5), and an internal above part (3-1) of the ozone gas-water storage and mixing tank (3) via the pipe (4-1) and the internal below part (2-2) of the pure water tank (2). The ozone and ozone water are further stored in the internal below part (3-2) of the ozone gas-water storage and mixing tank (3) and a storage room of the ozone gas delivery pipe (7). When the ozone generator is turned off for a period, the DC power supply (8) continues providing the half-loaded current (Im) for the ozone generator (1) to operate; wherein, the half-loaded current (Im) is half smaller than a full-loaded current (If). When a predetermined time 58 minutes is reached, the DC power supply (8) instantly offers the full-loaded current (If) to the ozone generator, thereby triggering the ozone generator to automatically operate for 2 minutes. The method is periodically and continuously applied.

### Embodiment 3

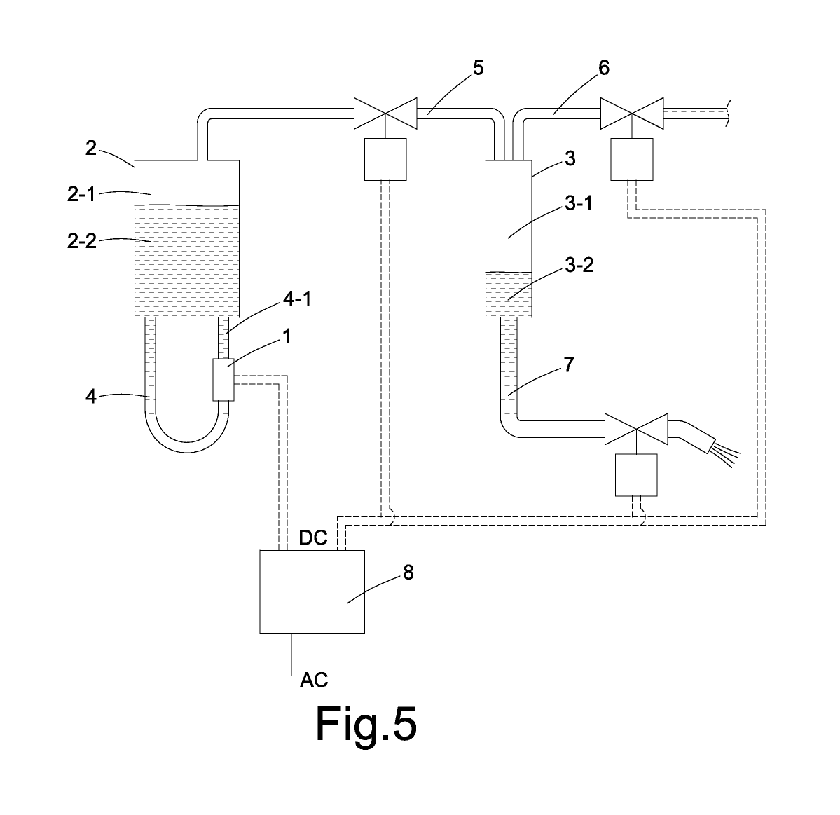

A method for keeping ozone of high concentration while turning on an electrolysis-type ozone water device (as shown in FIG. 5) utilizes an ozone generator (1) connected to a pure water tank (2) via a pipe (4) and another pipe (4-1). A top side between the pure ware tank (2) and an ozone gas-water storage and mixing tank (3) is connected by the pipe (5). The ozone gas-water storage and mixing tank (3) includes a tap water input pipe (6) disposed at a top end thereof. The ozone gas-water storage and mixing tank (3) further includes the ozone gas delivery pipe (7) (or an ozone water delivery pipe (7)) disposed at a lower end thereof. The pipe (5), the tap water input pipe (6), and the ozone gas delivery pipe (7) are respectively installed with the controlling valve for triggering the ozone generator. The DC power supply (8) provides electricity for the ozone generator and the controlling valve. When the ozone generator (1) is turned on for generating ozone, the ozone is stored in a storage room defined in the internal above part (2-1) of the pure water tank (2), the pipe (5), and an internal above part (3-1) of the ozone gas-water storage and mixing tank (3) via the pipe (4-1) and the internal below part (2-2) of the pure water tank (2). The ozone and ozone water are further stored in the internal below part (3-2) of the ozone gas-water storage and mixing tank (3) and a storage room of the ozone gas delivery pipe (7). When the ozone generator is turned off for a period, the DC power supply (8) continues providing the half-loaded current (Im) for the ozone generator (1) to operate; wherein, the half-loaded current (Im) is half smaller than a full-loaded current (If). When a predetermined time 1 hour is reached, the DC power supply (8) instantly offers the full-loaded current (If) to the ozone generator, thereby triggering the ozone generator to automatically operate for 5 minutes. The method is periodically and continuously applied.

I claim:

1. A method for keeping ozone of high concentration while turning on an electrolysis-type ozone device, wherein, in said ozone device, an ozone generator (1) is connected to a pure water tank (2) via a pipe (4) and another pipe (4-1); said pure water tank (2) is connected to the other pipe (5); said pipe (5) is connected to an ozone gas delivery pipe (7); on said pipe (5) and said ozone gas delivery pipe (7), a controlling valve is disposed to control an operation of said ozone generator; a DC power supply (8) provides electricity for said ozone generator and said controlling valve; ozone gas is generated when said ozone generator is turned on to be stored in an internal above part (2-1) of said pure water tank (2), said pipe (5) and a storage room of said ozone gas delivery pipe (7) via said pipe (4-1) and an internal below part (2-2) of said pure water tank (2); characterized in that when said ozone generator is turned off for a period, said DC power supply (8) continues providing a half-loaded current (Im) for said ozone generator (1) to operate; wherein, said half-loaded current (Im) is half smaller than a full-loaded current (If); when a predetermined time that is set in a range from 0.5 hour to 24 hours is reached every time, said DC power supply (8) instantly offers said full-loaded current (If) to said ozone generator, thereby triggering said ozone generator to automatically operate for 0.5 minute to 60 minutes; said method being periodically and continuously applied.

2. The method as claimed in claim 1, wherein, an ozone gas-water storage and mixing tank (3) is disposed between said pipe (5) and said ozone gas delivery pipe (7) and includes a tap water input pipe (6) disposed at a top end thereof; said tap water input pipe (6) is installed with said controlling valve; said DC power supply (8) provides electricity for said ozone generator and said controlling valve; when said ozone generator (1) is turned on for generating ozone, said ozone is stored in a storage room defined in said internal above part (2-1) of said pure water tank (2), said pipe (5), and an internal above part (3-1) of said ozone gas-water storage and mixing tank (3) via said pipe (4-1) and said internal below part (2-2) of said pure water tank (2); said ozone and ozone water are further stored in said internal below part (3-2) of said ozone gas-water storage and mixing tank (3) and a storage room of said ozone gas delivery pipe (7).

3. The method as claimed in claim 2, wherein, said ozone gas-water storage and mixing tank of said ozone device adopts a single gas storage jar or any other suited assemblies.

4. The method as claimed in claim 1, wherein, said ozone device adopts an ozone gas generator that outputs ozone gas, an ozone air generator that outputs mixed ozone air, or an ozone water generator that outputs ozone water.

5. The method as claimed in claim 1, wherein, said storage room in said ozone device is airtight.

6. The method as claimed in claim 2, wherein, said storage room in said ozone device is airtight.
